(19) United States
(12) Patent Application Publication
(10) Pub. No.: US 2015/0182841 A1
(43) Pub. Date: Jul. 2, 2015

(54) Communication Module for Personal Performance Monitoring and related Arrangement and Method

(71) Applicant: Suunto Oy, Vantaa (FI)

(72) Inventors: Mikko Martikka, Vantaa (FI); Kimmo Pernu, Vantaa (FI); Erik Lindman, Vantaa (FI)

(21) Appl. No.: 14/585,255

(22) Filed: Dec. 30, 2014

(30) Foreign Application Priority Data
Dec. 31, 2013 (FI) 20136346

(51) Int. Cl. A63B 71/06; H04Q 9/00

(52) U.S. Cl. CPC A63B 71/06; H04Q 9/00

(57) ABSTRACT

The invention relates to a communication module for personal physical performance monitoring and/or facilitation, and a related system and method. The module comprises means for mounting the communication module to a mounting zone on a sports item, the means for mounting comprising two or more electronic contact terminals for making an electronic contact with the sports item while being mounted thereon. The module additionally comprises a wireless communication unit for communicating with a remote monitoring device, and a processing unit functionally connected to said contact terminals and to said wireless communication unit and capable of processing data received through the contact terminals and/or the wireless communication unit according to data processing instructions. According to the invention, the communication module comprises means for reading an identifier from the sports item while being mounted thereon, and the processing unit is capable of changing said data processing instructions based on the identifier read from the sports item. The invention improved modularity of personal-area sports monitoring systems, for example.

### FIELD OF THE INVENTION

The invention relates to communication systems used in personal performance monitoring for example during sports acts. In particular, the invention relates to a novel communication module suitable for communicating sensor signals, such as EMG signals. The invention also relates to a communication arrangement and a communication method.

### BACKGROUND OF THE INVENTION

It is well known to measure electromyographic (EMG) signals from different parts of a human body during sports performances, the most common example being hear beat measurement using a surface EMG sensor-containing heart beat belt with a wireless transmitter module for communicating with a monitoring device, such as a sports watch. Measurement of surface EMG signals also from other parts of the body to monitor muscle activity in legs, arms, middle body or torso, for example. Such measurements can be carried using EMG sensors for example integrated into sports garment. It is also known to integrate signal transmitter modules into the belt or garment or to provide the module as a snap-on module to an assembly zone on the garment or belt. The module can be removed for washing the garment, for example. One disadvantage in known systems is that, although the transmitter can be removable and reconnectable, each sensor or sensor group requires a specifically designed transmitter module in order to operate properly.

To mention some specific examples, U.S. Pat. No. 8,253,586 discloses a performance measuring system comprising an article of clothing with an integrated measuring sensor and additionally a communication module, power module and computing module attachable to the article of clothing. The modules can be removed from one article of clothing and used in another article of clothing, while the sensor remains in the article. EP 1531726 discloses the use of a multitude of surface EMG electrodes to gain information simultaneously from muscles in various parts of the body. Also U.S. Pat. No. 4,583,547 relates to a similar application and in particular how conductive paths in garment can be arranged to provide a sensor signal form the measurement point to the signal transmitter module.

US 2008/0319330 discloses as a further example of currently available techniques a mobile transmitter for observing performance-related events and transmitting data on the observed events to a receiver. The transmitter comprises a timer for providing time references relating to the events and a memory for recording time references. The transmitter obtains a time reference from the timer and records the obtained time reference in the memory and is adapted to produce data messages containing a predetermined number of time references obtained from the memory and further to transmit the produced data messages to the receiver. The disclosed system allows for time stamping of events, such as heartbeats, and calculating the frequency and/or interval variation parameters of heartbeats. The system does not allow for synchronizing events from different detector sources.

U.S. Pat. No. 7,698,101, on the other hand, discloses a system for pairing sensor-containing shoes with measurement electronics, including authentication of the shoes for the electronics. Also these solutions require dedicated transmitter module sensor pairs in order to be able to transmit the measurement signal to a monitoring unit. US 2013/0096704 discusses articles of clothing and module capable of sensing physical and/or physiological characteristics associated with the use of the clothing. The module contains one or more integral sensors. The system can activate the module or sensor in it upon engaging the module to the clothing and confirm that the clothing and the module are authorized for use with one another and/or for automatic data processing algorithm selection. The flexibility of the system is, however, restricted to adaptation of the sensor module to use its built-in sensor(s) in different ways depending on the clothing it is attached to. Thus, several modules are still needed or a single module needs to be equipped with a plurality of sensors if different types of signals are to be measured.

One problem also touched by the abovementioned publications in a multi-sensor system is the communication of the different EMG measurement signals to a single monitoring device. There are systems, which utilize wired communication channels from a plurality of sensors to a single module. Such systems become impractical if there is a need to use many sensors at distant body parts and potentially separate belt or garment units.

Thus, there exists a need for generic solutions for facilitating communication between sports items, such as EMG sensor-containing garment, and a central monitoring unit.

### SUMMARY OF THE INVENTION

It is an aim of the invention to solve at least some of the abovementioned problems and to provide a communication module, which allows for communication between different kinds of sports items and a single monitoring unit.

An aim of the invention is also to provide a related modular communication system.

A further aim is to provide a method for monitoring and/or facilitating physical performance of a person.

The invention is based on the general idea of arranging a data processing and communication link between a sports item and a central monitoring unit in a novel way. In focus of the invention, there is a communication module, which is capable of distinguishing the place of mounting thereof so that it may adapt its internal operation accordingly, and a sports system or arrangement comprising such communication module and a sports item with a mounting zone capable of indicating its identifier to the communication module once being mounted thereon.

In more detail, to meet the abovementioned aims, the invention provides a programmable communication module for personal physical performance monitoring and/or facilitation, the module comprising means for mounting the communication module to a mounting zone on a sports item. Said means for mounting are equipped with two or more first electronic contact terminals for making an electronic contact with the sports item while being mounted thereon. In addition, the module comprises a wireless communication unit for communicating with a remote monitoring device, and a processing unit functionally connected to the abovementioned contact terminals and to the wireless communication unit. The processing unit is capable of processing data received through the first contact terminals and/or the wireless communication unit according to data processing instructions programmed therein. The processing unit is also reprogrammable, i.e., capable of changing the data processing instructions based on a sports item-specific identifier contained in and read from the sports item the module is mounted on. For this purpose, the communication module additionally comprises means for reading the identifier from the sports item while being mounted thereon. The reprogramming can have effect on various characteristics, including data processing characteristics and communication characteristics (towards either or both the monitoring unit and electronics contained in the sports item), of the module. Thus, a single general-purpose detachable communication module is sufficient to serve for the communication and data processing needs for a large number of different kinds of sports items, provided that they comprise similar mounting zones and similarly readable identifiers. The module therefore allows for communication of processed data between the sensor or actuator in the sports item and the wireless communication unit and is further capable of adapting itself internally according to the sports item which it is mounted to.

The invention also provides an arrangement for personal performance monitoring and/or facilitation. The arrangement comprises one or more communication modules as described above and one or more sports items each comprising a mounting zone for the communication module, the mounting zone comprising two or more second electronic contact terminals for making an electronic contact with the first electronic contact terminals of the communication module when mounted to the mounting zone. There is also provided in the sports item a memory unit for storing an identifier of the sports item and means for communicating the identifier to the communication module when mounted to the mounting zone. Said means may comprise embedded electric wires in the sports item, for example. There are also one or more sensors or actuators functionally connected to the second contact terminals so as to be able to transfer electric signals between the one or more sensors or actuators and the communication module. The communication module is capable of reading the identifier from the sports item and adapting its internal functions accordingly.

The invention also provides a method of monitoring and/or facilitating personal physical performance of a person. The method comprises measuring performance-related parameters using one or more sensor-containing sports items carried by the person and/or providing performance-related actuation signals to one or more actuators contained in the one or more sports items, and providing said performance-related parameters to or actuation signals from a wireless monitoring unit through one or more communication modules connected to the sports items and wirelessly connected to the monitoring unit. The method further comprises reading, by the one or more communication modules, digital identifiers from the sports items the communication module(s) are connected to, and adapting internal operation of the one or more communication modules based on the value(s) of the digital identifier(s).

More specifically, the invention is defined in the independent claims.

The invention has considerable advantages. Importantly, the invention allows for a single communication module to be used together with a variety of different peripheral devices, most notably sensors and actuators herein discussed. The functions of the device are determined only once attached to the item containing the sensor or actuator, by reading an identifier of the item and self-adapting the module according to the identifier.

The invention significantly improves modularity of existing sports monitoring or facilitation systems. By means of the invention, a single generic communication module can be used with sports garment and other sports items designed for particular sports. For example, the same module can be used during one training session in a heart rate belt for heart rate signal processing and transmission and in another sessions attached to muscle EMG sensor-containing clothing for muscle activity detection and activity signal transmission, or even a foot pod or bicycle pod for speed signal processing and transmission, to mention a completely different kind of measurement. By means of the invention, it is also convenient to build distributed performance monitoring systems with sensors grouped in suitable single-sensor units and/or multi-sensor groups each serving for a particular purpose and associated with a single communications module. Although the system is distributed, the amount of physical wiring can be kept reasonable because of wireless communication between the communication modules and the monitoring unit.

Long wires as used in prior art solutions are sensitive to interference, as the EMG voltages are low. With the aid of the invention, robust data transfer between the measuring points and a monitoring unit can be established. Only the wires between the sensors or actuators and the distributed mounting zones need to be integrated to the garments, for example.

The invention can be used with any sports items within a personal-area network of a person. This includes at least all items that the person wears, holds or touches during the performance.

Adaptivity of the module can be implemented in a variety of ways, including choosing suitable processing instructions from a set of processing instructions pre-stored in the module, over a two-way data communication channel with a monitoring unit carried by the user, over a two-way data communication channel with a computer, or over a two-way internet data communication channel (cloud service).

Dependent claims focus on selected embodiments of the invention.

According to one embodiment, there is provided a communication module comprising conductive means for mounting the communication module to a mounting zone on a sports item, the conductive means forming both physical mounting points and electronic contact terminals for making an electronic contact with the sports item while being mounted thereon.

According to one embodiment, the wireless communication unit of the module is capable of transmitting data received through the contact terminals and processed in the module to a remote monitoring device. This allows the module to be used with sensor-containing sports items.

According to one embodiment, the wireless communication unit is capable of both sending data to and receiving data from the remote monitoring device. This embodiment further allows receiving processing instructions not initially stored in the memory of the module, extending the range of use of the module greatly.

According to one embodiment, the processing unit of the module is functionally connected to said contact terminals and to said wireless communication unit and capable of processing data received through the contact terminals and for storage and/or transmission of the processed data through the wireless communication unit according to data processing instructions contained in memory thereof. According to a further embodiment, the processing unit is capable of processing data received through the wireless communication unit and transmitting the data through the contact terminals. Thus, either one- or two-way communication, and optional intermediate data processing, between the wireless communication unit and the contact terminals is possible.

According to one embodiment, the communication module comprises means for reading an electronic identifier in the form of a data field in an electronic memory device contained in the sports item and accessible by the module.

According to one embodiment, the means for reading the identifier from the sports item are adapted to read the identifier from the electronic memory device over a wired connection through the contact terminals. Thus, no separate connectors for reading the identifier are needed in the module. Alternatively, the means for reading the identifier comprise wireless transceiver unit, such as a radio-frequency identification (RFID) unit, for reading the identifier from a sports item equipped with a corresponding transponder containing the electronic memory device. This embodiment requires more additional electronics in the module but allows for contactless reading of the identifier and spares the contact terminals of sensor/actuator communication use only.

Both the communication and data processing characteristics of the processing unit are preferably capable of being changed upon operating environment-specific reprogramming of the processing unit, i.e., changing the internal data processing instructions of the processing unit based on the identifier read.

According to one embodiment, the module comprises an internal memory for storing a set of data processing instructions corresponding to different identifiers and the processing unit is capable of choosing the data processing instructions from said set of data processing instructions based on the value of the identifier read. This embodiment allows for a set of instructions for example corresponding to identifiers of most common sports items, such as a heart rate belt and selected pieces of muscle activity sensor garment.

Alternatively or in addition to containing an internally stored set of instructions, the processing unit may capable of sending a request for data processing instructions corresponding to the value of the identifier read and receiving said data processing instructions through said wireless communication unit to/from an external wireless device, preferably said monitoring unit, and optionally storing the received data processing instructions in the set of data processing instructions in the internal memory for also further use. This embodiment extends the use of the module to all kinds of applications not even known at the moment of release of the module.

To implement potentially most typical use, sensor co-operation, of the module, the processing unit is capable of receiving a sensor signal from the sports item through the contact terminals and processing the sensor signal according to the data processing instructions chosen to provide processed sensor data. Further, the processing unit is adapted to transmit the processed sensor data to the monitoring device through the wireless communication unit. The following sensor signals may be supported, for example: EMG signal from an EMG sensor, acceleration signal from an acceleration sensor, power signal from a power sensor, speed signal from a speed sensor, position signal from a satellite positioning sensor, pressure signal form a pressure sensor. Further uses are discussed elsewhere in the document. It should be noted that in the software level, the changeable processing instructions of the processing unit determine the operation of the processing unit, but the module must be designed in the hardware and firmware levels to enable such functionalities.

According to another main use of the module, the processing unit is capable of receiving actuation data from the monitoring device through the wireless communication unit, processing the actuation data according to the data processing instructions chosen to provide an actuation signal, and transmitting the actuation signal to the sports item through the contact terminals according to the data processing instructions. This kind of actuator co-operation (or “facilitation” use) is roughly inverse to the sensor co-operation. The actuation signal may be a power signal, trigger signal or display drive signal, for example, or any combination thereof. Again the module must be designed in the hardware and firmware levels to enable such functionalities upon suitable reprogramming in the software level. I.e., there must be some power output capacity in the module for allowing sports items without internal power supplies to be used.

According to one embodiment, the module comprises a sensor of some kind, such as an acceleration sensor, functionally connected to the processing unit and a memory with data processing instructions for processing sensor data received from the sensor. This embodiment allows the module to be used also in a stand-alone mode to detect for example acceleration changes. Thus, the module can be used for example as a step detector (foot pod) with ordinary shoes or with shoes only containing a physical mounting zone for the module.

Apart from the mounting means and contact terminals of the module, all other key parts thereof are preferably contained in a housing. In particular, the housing encapsulates the wireless communication unit and the processing unit. The mounting means and the contact terminals are located on outer surface of the housing such that they are easily accessible.

The mounting means and the contact terminals are preferably integrally formed of at least two conductive snap fasteners, such as male or female snap fasteners, being capable of engaging with corresponding conductive counterparts on the sports items so as to attach the module to the sports item and to form said electric contact between the module and the sports item.

According to one embodiment, the present sports items comprise a mounting zone for the communication module, the mounting zone comprising two or more second electronic contact terminals for making an electronic contact with the first electronic contact terminals of the communication module according to the invention when mounted to the mounting zone. The mounting zone may comprise e.g. female or male snap fasteners designed to engage corresponding parts of the module described above. Embedded in the sports item, there is a memory unit for storing an identifier of the sports item, the memory unit being connected to means for communicating the identifier to the communication module when mounted to the mounting zone. Such means may be comprise conductors for contact reading of the memory vie the second contact terminals or a radio-frequency transponder unit for wireless reading. In addition, there are one or more sensors or actuators functionally connected to the second electronic contact terminals so as to be able to transfer electric signals between the one or more sensors or actuators and the communication module via the second contact terminals.

The mounting means of the communication module and the mounting zone of the sports item are preferably designed to allow for repetitive mounting and removing of the communication module(s) thereto/therefrom. Thus, the module can be removed if a person wants to use the module in another sports item or for example during washing of the sports item or charging or changing of a battery of the module.

Indeed, according to one embodiment, the communication module comprises an electric power source, such as a battery, or a zone for placing a power source adapted to power internal functions of the communication module and to provide power to said electronic contact terminals. The internal functions include in particular operation of the communication unit (radio unit), processing unit and means for reading the identifier.

In one particular embodiment, the number of second electronic contact terminals in the sports item is two and the terminals are connected both to said memory unit and to the one or more sensors or actuators. The communication link through corresponding first terminals of the communication module and the second terminals of the sports item is arranged such that signal from/to the memory unit and from the sensor(s)/to the actuator(s) are distinguishable, e.g. by their frequency characteristics, so that both the memory unit and the sensor(s)/actuator(s) are useable.

The sports item may be a belt, garment or piece of sports equipment, such as a bat, racket, club, ski or bicycle, with one or more integrated sensors or actuators. Further examples are discussed elsewhere in this document.

The communication module and the sports item according to the invention is preferably used in a system additionally comprising a monitoring unit capable of wirelessly communicating with the communication module so as to receive sensor data from said one or more sensors or transmit actuation signal to said one or more actuators via said communication module. In such system, the communication module is preferably capable of sending a request for data processing instructions corresponding to the value of the identifier read from the sports item to the monitoring unit and receiving said data processing instructions from the monitoring unit, and the monitoring unit is capable of receiving and processing said request and transmitting said data processing instructions wirelessly to the communication module. Processing of the request may comprise retrieving the data processing instructions from a memory of the monitoring unit and/or further requesting the data processing instructions from an external computer or a cloud service.

According to one embodiment, the sports item contains, in addition to the sensor or actuator, also analogue and/or digital processing unit, which is capable of processing the sensor data before sending to the contact terminals and further to the communication module, or processing signals intended for the actuator. The processing unit typically comprises a microcontroller embedded in the sports item. This embodiment allows for even more generic communication modules to be used, as part of signal processing or intelligent logic operations can be implemented in the sports unit level, as in integral part and function of the sports item. Preferably, the processing unit is powered by the communication module but may naturally contain also a separate power source. In particular, there may be sensor signal A/D conversion and processing logic in a sensor-containing sports item. The processing may be located either in the vicinity of the sensor or in the vicinity of the mounting zone for the communication module. In this embodiment, the identifier may be provided for the communication module a memory of the processing unit, whereby any separate memory unit for storing the identifier is not needed. The signal for the contact terminals of the sports item may contain both the identifier and any additional data from the sensor processed in the integral processing unit. It is also possible to provide a two-way wired communication between the communication module and the integral processing unit of the sports item so that preprocessing instructions, for example, are given for the integral processing unit from the communication module.

According to one embodiment, all communication modules in the system, irrespective of their place of mounting, are similar in their hardware design and the operational differences are achieved solely by reprogramming according to the invention based on the identifiers read form the mounting zones.

According to a further aspect of the invention, there are provided sports pants comprising a plurality of integrated EMG sensors adapted to sense EMG signals from at least two leg muscles, such as frontal and/or back thigh muscles, preferably from both legs. There is also provided one or more mounting zones for communication modules as described above, the mounting zones comprising module-readable identifiers. The EMG sensors are connected to contact terminals contained in the mounting zones by wires integrated to the garment structure. The number of mounting zones is typically one (all sensors connected thereto and their signals processed in a module attached thereto) or two (sensors arranged in two groups and their signals processed separately), but may be also larger (more sensor groups).

### DEFINITIONS

The term “sports item” covers various pieces of garment and other items used when performing sports. In particular, the term covers personal clothing and other wearable items, such as heart rate belts, and personal sports equipment in direct possession of the person performing the sport. The term also covers other sports items that are at least temporarily in the vicinity of the person during the performance, i.e., can join the personal-area network of a central unit (monitoring unit) of the person. An example of such item is a golf bag. Further examples are given in the detailed description. “Sports” should be taken broadly to cover all kinds of physical activities.

“Mounting zone” is zone on a sports item dedicated or at least suitable for a communication module according to the invention. A mounting zone comprises both physical and electronic connection means for the communication module to both remain attached to the sports item and to be able to electrically communicate with one or more sensors and/or actuators therein.

“ID” or “identifier” in a sports item is a piece of machine-readable data which indicates the type of the sports item in particular in respect of number and type(s) of sensor(s) and/or actuator(s) therein for allowing a communication module attached to the mounting zone to utilize them. The identifier can be coded in any suitable machine-readable format encoding a specific value. Therefore, references to the “identifier” can be considered as references to the “value of identifier”, where applicable. The identifier can for example be a sequence of characters bit-encoded and stored in a semiconductor memory unit.

“Processing instructions” means computer-readable code (typically arranged in a single data file) with data content, which can be interpreted by the communication module to change its operation to correspond with the requirements of a sports item with a specific ID. The instructions may have effect for example on
sensor signal (input signal) processing characteristics (e.g. amplification characteristics) of the module,
actuator control signal (output signal) processing characteristics,
internal sensor or actuator data processing algorithms,
data interface specifications with a sensor and/or actuator, and/or
wireless data communication characteristics with a monitor unit.

The processing instructions may comprise a set of configuration values (passive instructions), computer-executable code (active instructions), or both, in a suitable data structure, most commonly in one or more data file. Thus, the processing instructions are sports item-specific software configuration files or applications, which can be utilized or run by the operating system (firmware) of the module.

“Monitoring” means receiving information on the performance using one or more sensors in one or more sports items through one or more communication modules according to the invention. Monitoring is preferably carried out using a wearable monitoring unit, such as a wristop computer, but may be done also using any other computing device capable of communicating with the one or more communication modules. One option is to use a mobile phone as the monitoring unit.

“Facilitation” means actively providing input to a sports item through a communication according to the invention. Facilitation can be carried out using one or more actuators in one or more sports items. Activation or control signals for the actuator(s) are provided from or via the communication module(s) and they may originate from the monitoring unit discussed above.

Next, embodiments of the invention and advantages thereof are described in more detail with reference to the attached drawings.

### BRIEF DESCRIPTION OF THE DRAWINGS

FIG. 1A illustrates a monitoring system according to one embodiment of the invention with communication modules attached to sports garments with integrated EMG sensors.

FIG. 1B illustrates a monitoring system according to another embodiment of the invention utilizing EMG sensors integrated with sports garments.

FIG. 2 shows another exemplary monitoring system with communication modules attached to garment with an integrated EMG sensor, tennis racket and shoe.

FIG. 3 shows a schematic side view of a communication module and mounting zone on a sports item.

FIG. 4 shows a schematic block diagram of a communication module according to one embodiment of the invention.

FIG. 5 illustrates a schematic block diagram of a monitoring unit according to one embodiment of the invention.

FIG. 6 illustrates a system extended from the monitoring unit to external devices or cloud services.

FIG. 7 shows a flow chart of the present method according to one embodiment.

### DETAILED DESCRIPTION OF EMBODIMENTS

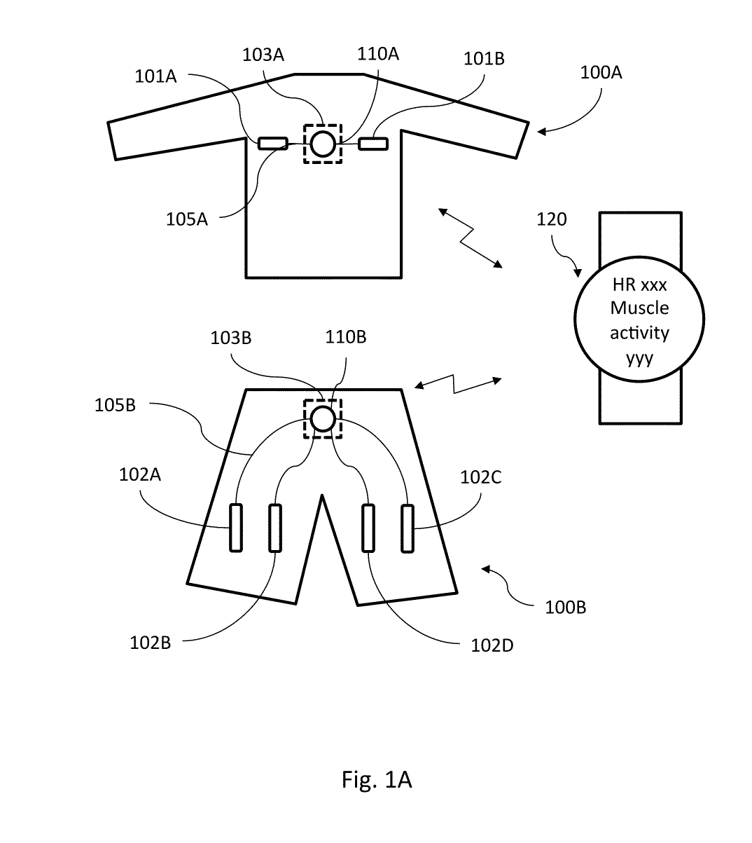

FIG. 1A shows one example of a system that can take advantage of the invention. The system comprises a first sports garment (shirt) 100A and a second sports garment (shorts) 100B, both containing integrated EMG sensors. The shirt 100A comprises first EMG sensor pads 101A, 101B positioned to measure heart EMG signal. In the shorts 100B, there are second EMG sensor pads 102A-D are positioned in two groups (102A and 102B/102C and 102D) against both thighs to measure thigh muscle EMG activity. The heart EMG pads 101A, 101B are connected to a first mounting zone 103A in the shirt 100A using first wirings 105A. Similarly, the thigh muscle activity EMG pads 102A-D of the shorts 100B are connected to a second mounting zone 103B in the shorts using second wirings 105B.

To the first and second mounting zones 103A, 103B, there are attached a first and a second communication module 110A, 110B, such that they are electrically connected to the first and second wirings 105A, 105B and further to the first and second EMG sensor pads 101A-B, 102A-D, respectively. Both the mounting zones 103A, 103B comprise communication module-readable identifiers, which are read by the communication modules 110A, 110B to be able to adapt the communication modules for these particular measurement environments. Thus, the modules 110A, 11B can be identical in hardware and firmware but can change their internal operating instructions to co-operate with the environment they are connected to.

There is also provided a monitoring unit (wristop computer) 120, to which the communication modules 110A, 110B wirelessly transmit the measurement information received from the sensors after processing in the processing units of the communication modules 110A, 100B. The monitoring unit 120 may also serve to provide the operating instructions for the modules 110A, 110B based on the identifiers read by the modules 110A, 110B upon request by the modules. The request and transmitting the instructions are preferably also done through wireless communication. Alternatively, the instructions corresponding to the identifiers may be stored in the modules 110A, 110B, whereby no communication with the monitoring unit 120 at the adaptation phase is needed.

To give an example of the adaptation of the modules, the identifier of the shirt 100A can “tell” the module 110A that there is one sensor (two pads) of EMG type connected and that the signal amplification level required is X. The identifier of the shorts 100B can “tell” the module 110B that there are two sensors (four pads) both of EMG type connected and that signal amplification level required for both of these is Y. As indicated above, the “telling” may take place through internal-only adaptation (instructions pre-stored in the module) or through communication with another device, such as the monitoring unit, a computer or a cloud service.

FIG. 1B illustrates a system otherwise similar to that of FIG. 1A but with the shorts 150B designed in an alternative way. The shorts 150B comprise mounting zones 153A, 153B for communication modules separately for each leg. The mounting zones 153A, 153B are connected to EMG sensors 152A-C, 162A-C arranged on each leg, respectively. The illustrates sensors 152A-C, 162A-C are located on the front and side portions of the legs and connected to the mounting zones 153A, 153B with suitable wirings integrated to the garments but there may be one or more additional sensors (not shown) on the back sides of the legs, again connected with wirings 152D′, 152E′, 162D′, 162E′. Thus, a complete muscular activity sensing system for each large muscle group and each leg is formed. Combined with the ECG signal from the subsystem of the shirt 100A, a comprehensive performance monitoring system is obtained.

Instead of two separate mounting zones 153A, 153B and respective identifiers therein at the pants 150B, there may be only one mounting zone or even more mounting zones. The illustrated sensor grouping is made only to exemplify the possibilities of the invention.

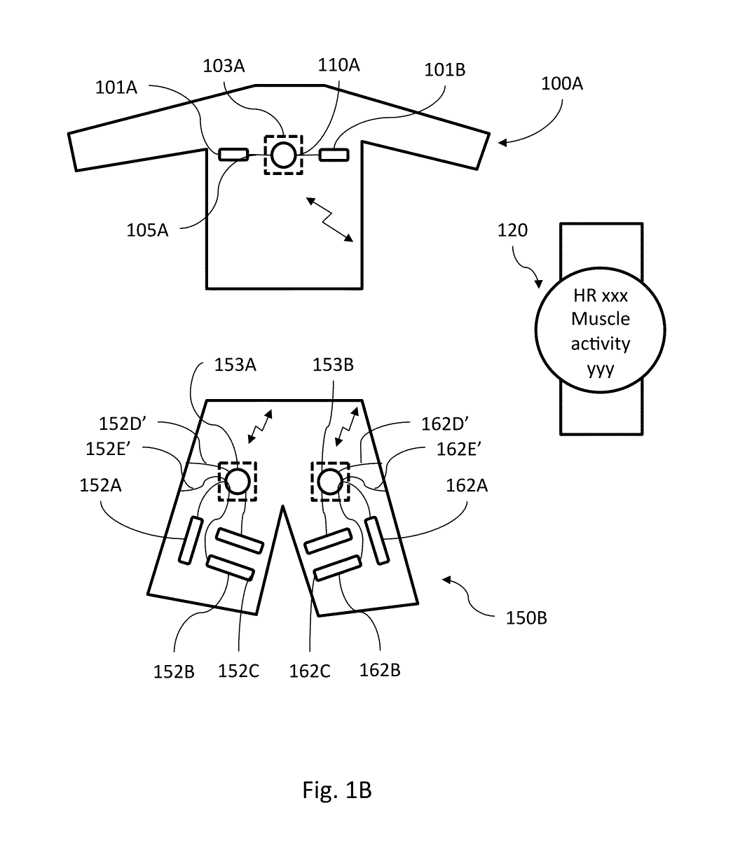

FIG. 2 shows a modified exemplary system with a sports garment 200 corresponding to the garment 100A of FIG. 1A. The EMG pads are denoted with reference numerals 201A, 201B, the first mounting zone with 203A, wirings with 205 and the first communication module attached thereto with 210A. The mounting zone 203A comprises a respective identifier readable by the module 210A.

In addition, there is provided a tennis racket 230 with a second mounting zone 203B and a second communication module 210B and a sports shoe 240 with a third mounting zone 203C and a third communication module 210C. The mounting zones 203B, 203C of the racket 230 and shoe 240 may be connected to acceleration sensors, orientation sensors or position sensors, to mention some examples, so as to be able to communicate corresponding tion, orientation or position information to the communication units 210B, 210C and further to the monitoring unit 220. The mounting zones 203B, 203C can also contain respective identifiers readable by the modules 210B, 210C to indicate what kind of operation of the communication modules 210B, 210C are required.

It is also possible that the racket 230 and/or shoe 240 are not provide with any sensors connected to the mounting zones 203B, 203C. In that case, their identifiers may “tell” the modules 210B, 210C that an internal sensor, such as an acceleration sensor, of the modules 210B, 210C are to be used. In this case, the identifiers can also be “void”. In other words, if a module is not able to find any identifier with specific data content (identifier code), it assumes by default to operate in a particular way, typically using its internal sensor and corresponding pre-stored processing instructions for usage of the internal sensor.

It should be noted that the sports items 100A, 100B, 200, 230 and 240 are preferably passive, i.e., are not provided with own power source. Instead of that, the power for both identifier-reading and sensor operations is obtained from power sources contained in the communication modules 110A, 110B, 210A, 210B and 210C.

The present modules can be used in connection with any sports items within the personal-area network of a person. Examples are pieces of garment carried out by the person, such as shirts, trousers, socks, hats, caps, footwear, handwear and belts and various pieces of sports equipment necessary for any particular sports, including rackets, bats, clubs, sticks, skis, bicycles, balls, vehicles, and bags.

Examples of sensors contained in the sports items include the EMG, acceleration, orientation, position sensors already mentioned above, and additionally temperature and pressure sensors, such as air pressure sensors or tactile sensors, and photosensors. Specific sensor types for the abovementioned purposes include conductive electronic potential sensors, micromechanical acceleration sensors, micromechanical gyroscopic sensors, micromechanical magnetic sensors, micromechanical pressure sensors, satellite positioning system sensors (e.g. GPS or GLONASS) and resistive and capacitive touch sensors (with optional touch position and/or touch force detection capability) and digital imaging sensors (e.g. multipixel CCD or CMOS sensors).

Specific sports item examples include heartbeat ECG belts, muscular EMG belts or garments and tennis rackets, golf clubs, skiing equipment with acceleration sensors or orientation sensors and photographic devices used during the performance.

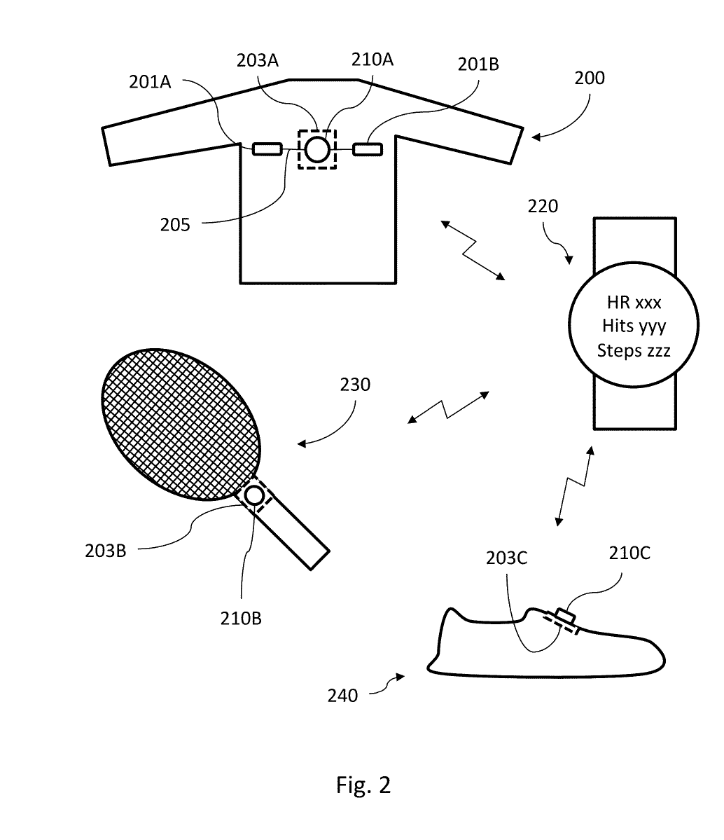

FIG. 3 illustrates two key components of the system, the communication module 310 and sports item 360 in more detail. The communication module 310 comprises a housing 317 and two electric contact terminals 311A, 311B on outer surface of the housing. In this example, the contact terminals 311A, 311B are in the form of bumps or buttons capable of being snapped into suitable recess counterparts 307A, 307B of a mounting zone 303 of a sports item 360 to provide both attachment and electric connection. There may also be provided separate or additional means to take care of these functions.

In the mounting zone 303, there is provided an identifier memory unit 309 electrically connected to the counterparts 307A, 307B. Thus, when the module 310 is connected to the mounting zone 303, it is able to access the memory unit 309 and read the identifier stored therein. In this example, the counterparts 307A, 307B are additionally connected to EMG sensor pads 301A, 301B using suitable wirings 305A, 305B in the sports item 360 to provide an EMG signal to the module 310.

The memory unit may comprise a memory circuit and a suitable interface circuit. A memory read command can be sent from the module to the interface circuit to read the identifier. The module may distinguish between identifier data and sensor input data by frequency characteristics of the signals.

As an alternative to the illustrated wired identifier memory unit reading, the reading may take place wirelessly. For example, there may be a radio-frequency identification (RFID) tag, such as a near-field communication (NFC) tag embedded in the mounting zone and the module contains a corresponding RFID/NFC reader unit for reading the identifier. In this case, the contact terminals of the module serve for sensor signal reading only.

If the sports item contains a local processing unit for processing sensor and/or actuator data, the memory unit can be integral with that processing unit or memory used by the processing unit.

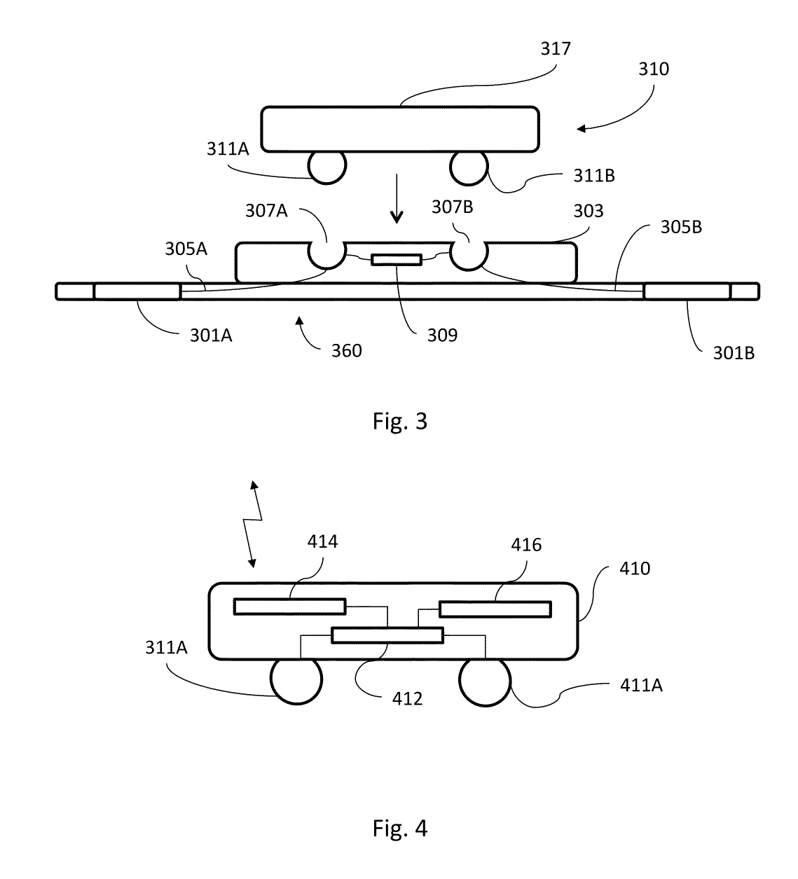

FIG. 4 shows in more detail the main internal components of a communication module 410 according to one embodiment of the invention. The module 410 comprises a processing unit 412 which controls and processes the input and output of the module via a wireless communication unit 414 (to and from a monitoring unit) and the contact terminals 311A, 311B (towards an identifier and sensor in a sports item). There may provided a separate input and/or output unit (not shown) between the processing unit 412 and the contact terminals 311A, 311B, the input and/or output unit comprising necessary circuits for amplification of the input signals, if needed.

The processing unit 412 typically comprises a microcontroller operated by firmware, and an amount of memory. There may also be a separate memory circuit (not shown) for storage of larger amounts of data. Tasks of the processing unit 412 include performing internal data processing actions of the communication module 410 and controlling communication to/from the monitoring unit and the sports item the module is attached to. Importantly, the processing unit executes the processing instructions selected on the basis of the ID read from the sports item.

The communication unit 414 comprises an antenna and necessary electronics for amplification of the received and transmitted signals and for coupling with the processing unit 412. The communication unit 414 can utilize any desired wireless communication protocol. The protocol is preferably a time slot-based protocol. Examples of suitable protocols include like Bluetooth LE and ANT+, using direct-sequence spread spectrum (DSSS) modulation techniques and an adaptive isochronous network configuration, respectively. A thorough description of the necessary hardware for various implementations is available e.g. from the Texas Instrument®'s handbook “Wireless Connectivity” which includes IC circuits and related hardware configurations for protocols working in sub-1- and 2.4-GHz frequency bands, such as ANT™, Bluetooth®, Bluetooth low energy, RFID/NFC, PurePath™ Wireless audio, ZigBee®, IEEE 802.15.4, ZigBee RF4CE, 6LoWPAN, Wi-Fi®, GPS.

For example, in the case of Bluetooth LE, an Attribute Profile (ATT) wire application protocol is used. An attribute is composed of three elements:
a 16-bit handle;
an UUID which defines the attribute type;
a value of a certain length.

A handle is a number that uniquely identifies an attribute and is expected to be stable for each device. A UUID (universally unique identifier) is an identifier standard used in software construction to enable distributed systems to uniquely identify information without significant central coordination. The value is an array of bytes of any size. The meaning of the value depends on the UUID.

Also TDMA-based protocols may be used, as discussed in “TDMA Protocol Requirements for Wireless Sensor Networks”, Sensor Technologies and Applications, SENSORCOMM '08. Second International Conference on 25-31 Aug. 2008, Pages 30-35, ISBN:978-0-7695-3330-8.

The module is powered by a power source 416, most typically a battery. There are also means (not show) for charging or allowing for changing the battery.

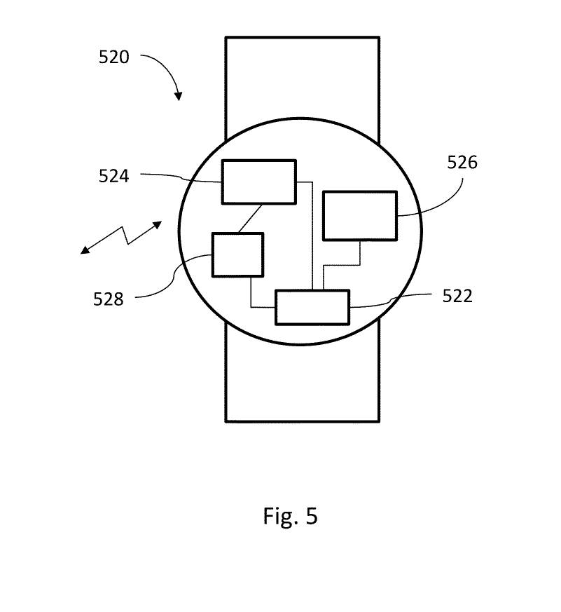

FIG. 5 depicts a monitoring unit 520 in the form of a wrist-worn computer. Also the monitoring unit comprises a processing unit 522 and a communication unit 524 for communication with one or more modules of the kind described above. There is also provided a memory unit 526 for storage of received/to-be-transmitted data. The communication unit utilizes the same wireless communication protocol as the communication modules(s) it is intended to communicate with, as described above.

One task of the processing unit 522 of the monitoring unit 520 is to collect messages sent by communication units in the same personal-area network and to display and/or store relevant information form the messages to the user via a display or to the memory unit for further use. According to one embodiment, the processing unit picks form the messages data measured by the remote sensors and information on the time of the measurements and orders the measurement data in a chronological order in one or more data structures.

The monitoring unit 520 is powered by a power source 528, typically a battery. There are also means (not show) for charging or allowing for changing the battery.

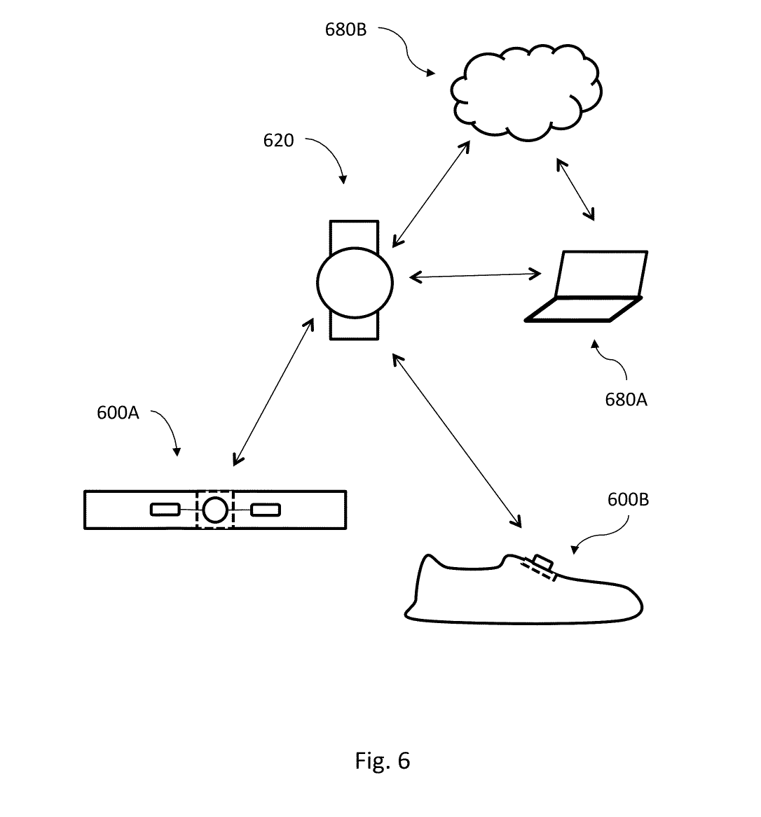

FIG. 6 shows a variation of the present system, extended from the monitoring unit 620 to cloud services 680B over the internet and/or to an external computer 680A. The purpose of the extension is that to provide processing instructions to the communication modules of the sports items 600A, 600B connected to the system, even in the case when the communication modules themselves or the monitoring unit does not initially contain processing instructions corresponding to the ID read from the ports items. In that case, the monitoring unit 620 can make a further request for correct processing instructions to the computer 860A and/or the cloud service 680B. Connection from the monitoring unit to the internet cloud service 680B is preferably wireless, using e.g. the WLAN or mobile internet protocols. Connection to the computer 680A may be wireless or a cable connection.

The processing instructions are preferably stored in and/or provided to the communication module as stand-alone applications, which can be run by the operating system (firmware) of the module. This allows for very generic modules still suitable for a variety of uses to be manufactured.

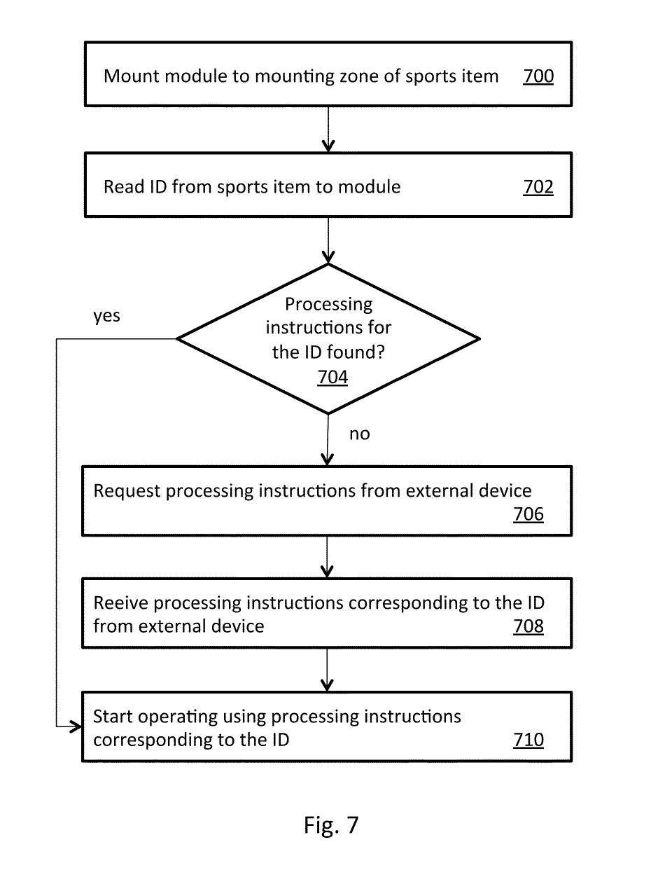

FIG. 7 shows a flow chart of the present method according to one embodiment. First, in step 700, the communication module is mounted to a mounting zone of a sports item designed to receive and hold the communication module thereon. The module makes electrical contact with the mounting zone via its contact terminals. Next, in step 702, the identifier of the mounting zone is read by the module, preferably via the electrical contact. Then, in step 704, the module checks if it is able to find processing instructions corresponding to the identifier read in step 702 from its own memory. If correct instructions are found, they are taken into use and the module is adapted according to the instructions. Then, the operation can be started in step 710. If, on the other hand, the module does not readily contain the correct instructions, it sends the identifier to an external device, typically a wristop monitoring unit, together with a request for instructions in step 706. The device processes the request and responds by sending the correct instructions to the module in a suitable format. In step 708, the module receives the instructions, before adapting its operation accordingly and starting of operation in step 710.

In the examples above, only sports items containing sensors functionally connectable with the communication module are discussed for simplicity. However, instead of or in addition to sensors, the sports items may contain actuators of any kind. An actuator differs from a sensor in that it produces a noticeable output for the user, whereas a sensor provides measurement information for the communication module to process and forward. The output may be visual, audible or mechanical (involving motion), for example.

Examples of actuators include an integrated display or audio output device in a garment. Another example is a tactile output device.

It should be noted that both sensors and actuators typically take the operating power from the communication module mounted to the sports item through suitable connectors and wirings.

It should be also noted that the options discussed are not exclusive. Thus, the device carried by the sports item may be a combined sensor and actuator. The sensing and actuation functions typically relate to each other, but they need not do so. Sensor data analysis and actuator control can be carried out in suitable electronics of the sports item itself, but is even more preferably carried out in the present programmable communication module, which takes input from the sensor, processes the input and controls the actuator. In the first case, only power is minimally required from the communication module to the sensor/actuator. In the latter case, also data signals needs to be transferred between the module and the sensor/actuator, which is of course possible in the first case too. If no immediate response is required, part of data processing and/or actuation control may be carried out in the monitoring unit over a wireless channel.

An example of a combined device is an EMG sensor with built-in visual or audible output of EMG signal, EMG signal frequency or indication of target EMG activity rate (e.g.: in coaching mode: advice to increase or decrease heartbeat). Another example is a GPS sensor with built-in speed and/or direction indicator. A still another example is a racket, bat or club which comprises an acceleration sensor and/or gyroscope and is able to provide instant feedback for the user on the characteristics of a hit or swing.

1. A communication module for personal physical performance monitoring and/or facilitation, comprising;
means for mounting the communication module to a mounting zone on a sports item, the means for mounting comprising two or more electronic contact terminals for making an electronic contact with the sports item while being mounted thereon,
a wireless communication unit for communicating with a remote monitoring device,
processing unit functionally connected to said contact terminals and to said wireless communication unit, and
means for reading an identifier from the sports item while being mounted thereon,
wherein the processing unit comprises:
means for processing data received through the contact terminals and/or the wireless communication unit according to data processing instructions for allowing communication of processed data between the contact terminals and the wireless communication unit, and
means for changing said data processing instructions based on the identifier read from the sports item.

2. The communication module according to claim 1, further comprising a memory for storing a set of data processing instructions corresponding to different identifiers and the processing unit is capable of choosing the data processing instructions from said set of data processing instructions based on the identifier read.

3. The communication module according to claim 1, wherein the processing unit is capable of sending a request for data processing instructions corresponding to the identifier read and receiving said data processing instructions through said wireless communication unit to/from an external wireless device.

4. The communication module according to claim 1, wherein said means for reading the identifier from the sports item are adapted to read the identifier through said contact terminals.

5. The communication module according to claim 1, wherein said means for reading the identifier from the sports item comprise a wireless transceiver unit for reading the identifier from a sports item equipped with a corresponding transponder.

6. The communication module according to claim 1, wherein the processing unit is capable of:
receiving a sensor signal from the sports item through the contact terminals,
processing the sensor signal according to the data processing instructions chosen to provide processed sensor data, and
transmitting the processed sensor data to the monitoring device through the wireless communication unit.

7. The communication module according to claim 6, wherein the processing unit is capable of receiving one of the following signals: EMG signal from an EMG sensor, acceleration signal from an acceleration sensor, power signal from a power sensor, speed signal from a speed sensor, or position signal from a satellite positioning sensor.

8. The communication module according to claim 1, wherein the processing unit is capable of:
receiving actuation data from the monitoring device through the wireless communication unit,
processing the actuation data according to the data processing instructions chosen to provide an actuation signal, and
transmitting the actuation signal to the sports item through the contact terminals according to the data processing instructions.

9. The communication module according to claim 8, wherein the actuation signal is a power signal, trigger signal or display drive signal.

10. The communication module according to claim 1, further comprising an acceleration sensor functionally connected to the processing unit and a memory with data processing instructions for processing sensor data received from the acceleration sensor.

11. The communication module according to claim 1, further comprising a housing encapsulating said wireless communication unit and said processing unit and said means for mounting and said contact terminals being located on outer surface of the housing.

12. The communication module according to claim 1, wherein said means for mounting and said contact terminals are integrally formed of at least two conductive snap fasteners being capable of engaging with corresponding conductive counterparts on the sports items so as to attach the module to the sports item and to form said electric contact between the module and the sports item.

13. The communication module according to claim 1, further comprising an electric power source adapted to power internal functions of the communication module and to provide power to said electronic contact terminals.

14. An arrangement for personal performance monitoring and/or facilitation comprising:
a communication module comprising:
means for mounting the communication module to a mounting zone on a sports item, the means for mounting comprising two or more electronic contact terminals for making an electronic contact with the sports item while being mounted thereon,
a wireless communication unit for communicating with a remote monitoring device,
processing unit functionally connected to said contact terminals and to said wireless communication unit, and
means for reading an identifier from, the sports item while being mounted thereon,
wherein the processing unit comprises:
means for processing data received through the contact terminals and/or the wireless communication unit according to data processing instructions for allowing communication of processed data between the contact terminals and the wireless communication unit, and
means for exchanging said data processing instructions based on the identifier read from the sports item,
and
one or more sports items each comprising
a mounting zone for the communication module, the mounting zone comprising two or more second electronic contact terminals for making an electronic contact with first electronic contact terminals of the communication module when mounted to the mounting zone,
a memory unit for storing an identifier of the sports item,
means for communicating the identifier to the communication module when mounted to the mounting zone, and
one or more sensors or actuators functionally connected to the second electronic contact terminals so as to be able to transfer electric signals between the one or more sensors or actuators and the communication module.

15. The arrangement according to claim 14, wherein the one or more sports items comprise one or more belts, garments and/or pieces of sports equipment with one or more integrated sensors or actuators.

16. The arrangement according to claim 14, further comprising a monitoring unit capable of wirelessly communicating with the communication module so as to receive sensor data from said one or more sensors or transmit actuation signal to said one or more actuators via said communication module.

17. The arrangement according to claim 16, wherein
the communication module is capable of sending a request for data processing instructions corresponding to the identifier read from the sports item to the monitoring unit and receiving said data processing instructions from the monitoring unit, and
the monitoring unit is capable of receiving and processing said request and transmitting said data processing instructions wirelessly to the communication module.

18. The arrangement according to claim 14, wherein the number of second electronic contact terminals is two and the terminals are connected both to said memory unit and to the one or more sensors or actuators.

19. A method of monitoring and/or facilitating physical performance of a person, comprising:
measuring performance-related parameters using one or more sensor-containing sports items carried by the person and/or providing performance-related actuation signals for the person using one or more actuator-containing sports items,
providing said performance-related parameters to or actuation signals from a wireless monitoring unit through one or more communication modules connected to the sports items and wirelessly connected to the monitoring unit,
reading, by the one or more communication modules, digital identifiers from the sports items the communication module(s) are connected to, and
adapting internal operation of the one or more communication modules based on the digital identifiers read.

20. The method according to claim 19, further comprising:
adapting the internal operation of the one or more communication modules by providing computer-readable processing instructions corresponding to said digital identifiers to the one or more communication modules, and
utilizing the processing instructions in the one or more communication modules;
to process the performance-related parameters measured and/or performance-related actuation signals, and/or
to communicate with the one or more sensor-containing sports items and/or the wireless monitoring unit.
